(19) United States
(12) Patent Application Publication
(10) Pub. No.: US 2015/0195226 A1
(43) Pub. Date: Jul. 9, 2015

(54) Interactive Picture Messaging System

(71) Applicants: Desiree Gina McDowell-White, Los Angeles, CA (US); Gilbert J. Arenas, Los Angeles, CA (US)

(72) Inventors: Desiree Gina McDowell-White, Los Angeles, CA (US); Gilbert J. Arenas, Los Angeles, CA (US)

(21) Appl. No.: 14/147,938

(22) Filed: Jan. 6, 2014

(51) Int. Cl. H04L 12/58; G06F 3/0482; G06F 17/30; G06F 3/0484

(52) U.S. Cl. CPC H04L 51/08; H04L 51/046; G06F 3/04842; G06F 3/0482; G06F 17/30106

(57) ABSTRACT

A messaging application system that allows users to use pictures to interact with each other by automatic inputting and/or sending pre-selected selected images when certain triggering words or phrases are detected.

### BACKGROUND OF THE INVENTION

1. Field of the Invention

The present invention relates to text messaging and, more particular, to automatically providing interactive pictures in a text messaging system.

2. Description of the Related Art

Mobile messaging over the internet and cellular network has been growing at an astonishing rate over the last decade. The usage of emoticons and images during conversations are common and require that a user select and input a particular character or image into a message prior to sending. Similarly, a user can receive a message having a picture or emotive character, but must manually response to such by replying and selecting a responsive character or picture. As pictures are much more expressive than words and provide the ability for users to represent their feelings and moods more effectively, there is a need in the art for a simpler and faster way to express feeling and moods when messaging.

### BRIEF SUMMARY OF THE INVENTION

The present invention comprises a messaging application system that allows users to use pictures to interact with each other by automatic inputting and/or sending pre-selected selected images when certain triggering words or phrases are detected. In addition, the present invention allows a user to established automatic picture responses based upon the text of incoming messages.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of the selection of a picture to be added to a message in response to a trigger according to the present invention;

FIG. 2 is a schematic of an automated response to the receipt of a message having a trigger therein according to the present invention;

FIG. 3 is a schematic of an automated picture selection and response according to the present invention.

### DETAILED DESCRIPTION OF THE INVENTION

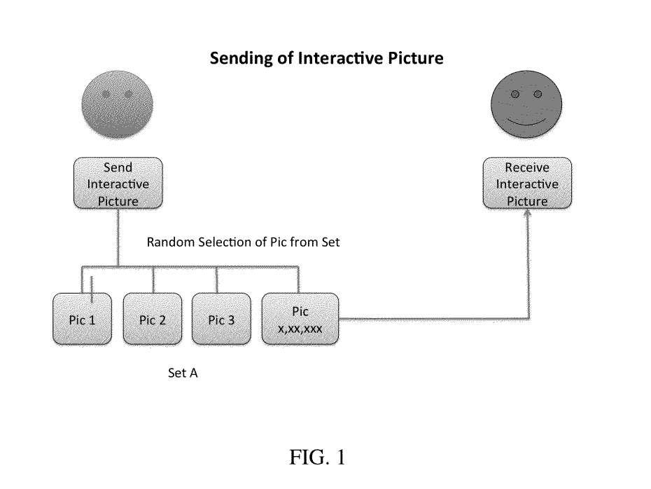

Referring now to the drawings, wherein like reference numerals refer to like parts throughout, there is seen in FIG. 1 a system 10 for automatically attaching a picture to an outgoing text message. Preferably, a user of the text messaging system configures system 10 by pre-assigning one or more pictures or images to each keyword that will automatically results in the addition of a picture or image to the message. For example, the trigger word “car” may be associated with pictures/images of a BMW automobile, a Ferrari racecar, a Porsche boxter, a handmade go-kart, etc. Similarly, the word “flag” could be paired with the country flag of the user or the flags for each country or state could be paired with the name of that country or state. It should be recognized by those of skill in the art that triggers used in system 10 can be pictures, words, phrases, or any other item that may be sent from one person to another via a messaging system. It should also be recognized that the picture being attached in response to detection of a trigger could comprise any type of image or file type, and may even comprise sounds or other types of attachments, such as spreadsheets, calendar entry files, etc.

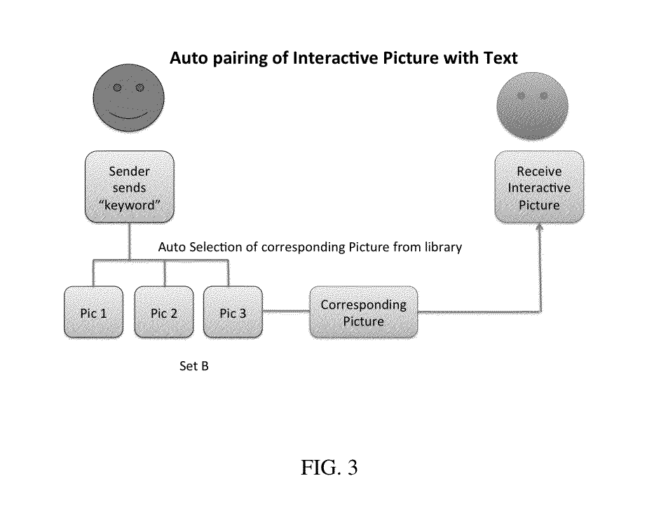

Once system 10 is configured to associate a pre-determined trigger with a picture or set of pictures, system 10 then automatically inserts the associated picture when it detects that the trigger has been input by the user. For example, when user enters or types the word “car” into a message to be sent, system 10 randomly selects a picture from the set of pre-configured pictures and attaches or appends it to the message. Alternatively, system 10 may be configured to cycle through the set of associated pictures, automatically select a picture as seen in FIG. 3, or give the user the option to select which picture will be attached.

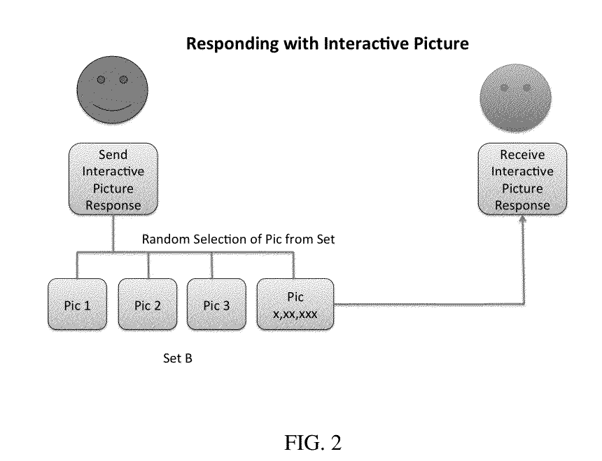

System 10 may further be configured to receive a message having one or more pictures associated therewith, such as a message sent according to the above descriptions. System 10 is further programmed to identify the attached picture, either by context, type, sender, or a pre-use configuration, and then respond to the identification with a response that has been authorized and/or configured by the user. For example, as seen in FIG. 2, the receiving user may be automatically prompted with one or more pictures to be added to a responsive message.

Alternatively, responsive user may configure system 10 to provide an automatic response. For example, if first sender sends a picture from a pre-configured set, such as a picture of a rock, a piece of paper, or a pair of scissors, the receiving user can authorize an automatic response from system 10 that includes a randomly selected picture from the same set. Thus, system 10 can allow users to interact effectively, and even automatically, using pictures. In another example, if receiving user's system 10 detects a trigger word, such as hungry, receiver's system 10 may response with a picture of receiving user's favorite restaurant.

What is claimed is:

1. A messaging system, comprising;
a database containing at least one pre-determined trigger associated with at least one file;
a first module for identifying the presence of said trigger in a message to be sent;
a second module for retrieving at least one file associated with said trigger from said database; and
a third module for attaching said at least one file to said message in response to identification of said trigger.

2. The system of claim 1, wherein said first module identifies the presence of said trigger by evaluating a text string that is input by a user to determine whether said text strong matches said trigger.

3. The system of claim 2, wherein said second module is programmed to retrieve multiple files associated with said trigger.

4. The system of claim 3, wherein said third module is programmed to allow a user to select which said file is attached to said message.

5. The system of claim 3, wherein said third module is programmed to randomly select which said file is attached to said message.

6. The system of claim 3, wherein said third module is programmed to sequentially select one ordered file from a set of ordered files and attached said ordered file to said message.

7. A messaging system, comprising;
a database containing at least one pre-determined trigger associated with at least one file;
a first module for identifying the presence of said trigger in an incoming message;
a second module for retrieving at least one file associated with said trigger from said database; and
a third module for attaching said at least one file to an outgoing message in response to identification of said trigger in said incoming message

8. The system of claim 7, wherein said first module identifies the presence of said trigger by evaluating a text string in said incoming message to determine whether said text strong matches said trigger.

9. The system of claim 8, wherein said second module is programmed to retrieve multiple files associated with said trigger.

10. The system of claim 9, wherein said third module is programmed to allow a user to select which said file is attached to said outgoing message.

11. The system of claim 7, wherein said third module is programmed to randomly select which said file is attached to said outgoing message.

12. The system of claim 7, wherein said third module is programmed to sequentially select one ordered file from a set of ordered files and attached said ordered file to said outgoing message.

13. A method of providing messaging, comprising the steps of:
searching a communication for a keyword;
attaching a file associated with said keyword to said communication upon detecting said keyword.

14. The method of claim 13, further comprising the step of allowing a user to a keyword with a file stored in memory.

15. The method of claim 13, wherein said communication is an incoming communication.

16. The method of claim 13, wherein said communication is an outgoing communication.

17. The method of claim 13, wherein said keyword is associated with a plurality of predetermined files and a user is allowed to select said file to be attached to said communication from one of said plurality of predetermined files.

18. The method of claim 13, wherein said keyword is associated with a plurality of predetermined files and said file to be attached to said communication is a randomly selected one of said plurality of predetermined files.
